(19) United States
(12) Patent Application Publication
(10) Pub. No.: US 2025/0326657 A1
(43) Pub. Date: Oct. 23, 2025

(54) IRON-BASED NANOPARTICLES AND METHODS OF PROCESSING

(71) Applicant: Niron Magnetics, Inc, Minneapolis, MN (US)

(72) Inventors: Andrew McGrath, Chanhassen, MN (US); Amy Bergerud, Minneapolis, MN (US); Francis Johnson, Minneapolis, MN (US)

(73) Assignee: Niron Magnetics, Inc, Minneapolis, MN (US)

(21) Appl. No.: 19/184,726

(22) Filed: Apr. 21, 2025

Related U.S. Application Data
(60) Provisional application No. 63/637,500, filed on Apr. 23, 2024.

(51) Int. Cl. C01G 49/08; C01G 49/06

(52) U.S. Cl. CPC C01G 49/08; C01G 49/06; C01P 2004/03; C01P 2004/45; C01P 2004/64; C01P 2004/84

(57) ABSTRACT

Methods and compositions including iron-based nanoparticles are provided herein. A method of processing an iron-based nanoparticle to form a capped iron-based nanoparticle may include introducing a cation and introducing an anion. The cation may bond to a portion of an outer region of the iron-based nanoparticle to define an intermediate nanoparticle. The anion may react with the intermediate nanoparticle to form a cation-anion coating, or a shell, on one or more portions of the outer region of the intermediate nanoparticle to form an iron-based capped nanoparticle. The cation-anion coating may cover only a portion of the outer region.

### CROSS-REFERENCE TO RELATED APPLICATIONS

This application claims priority to U.S. Provisional Patent Application No. 63/637,500, filed Apr. 23, 2024, the disclosure of which is hereby incorporated by reference in its entirety.

### FIELD

The present disclosure relates generally to compositions, systems, and methods comprising iron-based nanoparticles.

### BACKGROUND

Nanoparticles may be prone to coalescing with each other to form agglomerates to reduce exposed surface area to a lower energy formation. In forming agglomerates, nanoparticles may be attracted to each other via relatively weak forces (e.g., van der Waals) and may form relatively weak bonds with each other. The tendency to form agglomerates can lead to an increase the average size of a nanoparticle system.

### SUMMARY

Iron-based nanoparticles may be processed, or treated, to reduce formation of agglomerates. The iron-based nanoparticles may include iron-oxide compounds such as FeO₃ and FeO₄. In some embodiments, a method of processing iron-based nanoparticles includes introducing a cation to an outer region of the iron-based nanoparticle and subsequently introducing an anion to the outer region of the iron-based nanoparticle. The cation may bond to the outer region (e.g., via weak attractive forces) to define an intermediate nanoparticle. The anion may then react with the cation on the intermediate nanoparticle to form a cation-anion coating, or shell, on one or more portions of the outer region of the intermediate nanoparticle to form an iron-based capped nanoparticle. The shell may cover only a portion of the outer region, such that another portion of the outer region is exposed to the environment. The presence of the shell may reduce instances of nanoparticle agglomeration such that the nanoparticles remain as discrete, individual nanoparticles. The shell may be insoluble in water and resistant to high heat such that the shell can remain bonded to the outer region of the nanoparticles after additional processing. In some embodiments, the shell may keep the nanoparticle stable upon exposure to high heat such that any additional growth of the nanoparticle is reduced, and the mean size of the nanoparticle remains small.

According to one example (“Example 1”), a method comprises introducing a cation to an iron-based nanoparticle having an outer region, the cation bonding to a portion of the outer region and defining an intermediate nanoparticle and introducing an anion to the intermediate nanoparticle, the anion reacting with the intermediate nanoparticle to form a cation-anion coating on one or more portions of the outer region of the intermediate nanoparticle to form an iron-based capped nanoparticle.

According to another example (“Example 2”), further to Example 1, the iron-based capped nanoparticle includes iron oxide.

According to another example (“Example 3”), further to Example 2, the iron oxide includes any of Fe₂O₃ and Fe₃O₄.

According to another example (“Example 4”), further to Example 1, the cation is introduced at a target molar ratio, wherein the target molar ratio is from 0.1% to 5% relative to the iron-based nanoparticles.

According to another example (“Example 5”), further to Example 4, the anion is introduced in excess of the target molar ratio.

According to another example (“Example 6”), further to Example 1, introducing the anion further comprises introducing the anion at a substantially uniform rate of 1 to 100 mol/hour.

According to another example (“Example 7”), further to Example 1, the method further comprises suspending the iron-based nanoparticles in fluid prior to introducing the cation.

According to another example (“Example 8”), further to Example 7, the method further comprises mixing the iron-based nanoparticle and cation together in the fluid.

According to another example (“Example 9”), further to Example 8, introducing the anion further comprises dip-feeding the anion while the iron-based nanoparticle and metal cation are mixing.

According to another example (“Example 10”), further to Example 1, the method further comprises milling the iron-based nanoparticle prior to introducing the cation.

According to one example (“Example 11”), a method comprises suspending iron-based nanoparticles in a fluid, exposing the iron-based nanoparticles to a cation to form a mixture, mixing the mixture, and exposing the mixture to an anion such that the anion reacts with the cation to form a precipitate on a portion of an outer region of the iron-based nanoparticle to form a capped nanoparticle.

According to another example (“Example 12”), further to Example 11, the method further comprises milling the iron-based nanoparticles.

According to another example (“Example 13”), further to Example 11, exposing the iron-based nanoparticles with a cation further comprises introducing the cation at a target molar ratio, wherein the target molar ratio is from 0.1% to 5% relative to the iron-based nanoparticles.

According to another example (“Example 14”), further to Example 13, exposing the mixture to an anion further comprises introducing the anion at an excess of the target molar ratio.

According to one example (“Example 15”) a method comprises doping iron-based nanoparticles with an insoluble precipitate, wherein the iron-based nanoparticle includes iron oxide.

According to another example (“Example 16”), further to Example 15, doping the iron-based nanoparticles further comprises introducing a cation to the iron-based nanoparticles, the cation bonding to one or more portions of an outer region of the iron-based nanoparticles and introducing an anion to the iron-based nanoparticles, the anion reacting with the cation on the portion of the outer region of the iron-based nanoparticles to form the insoluble precipitate.

According to one example (“Example 17”), a composition comprises an iron-based nanoparticle having an outer region and a shell covering at least a portion of the outer region, the shell including a cation-anion pair.

According to another example (“Example 18”), further to Example 17, the iron-based nanoparticle has a mean aggregate size of less than 2 microns.

According to another example (“Example 19”), further to Example 17, the iron-based nanoparticle has a size of approximately 5 nanometers or greater.

According to another example (“Example 20”), further to Example 17, the iron-based nanoparticle has a size of approximately 40 nanometers or less.

According to another example (“Example 21”), further to Example 17, the cation-anion pair includes a metal cation including at least one of an alkali metal, an alkaline earth metal, or a transition metal, optionally including any one of Ca²⁺, Mg²⁺, Sr²⁺, Ba²⁺, Mn²⁺, or Cr²⁺.

According to another example (“Example 22”), further to Example 17, the cation-anion pair includes an anion including at least one of an oxide, a hydroxide, and a carbonate.

According to another example (“Example 23”), further to Example 17, the cation-anion pair includes at least one of ammonium carbonate, sodium carbonate, ammonium hydroxide, sodium hydroxide, trisodium phosphate, manganese hydroxide (Mn(OH)₂), manganese dioxide (MnO₂), or ammonium phosphate.

According to another example (“Example 24”), further to Example 17, the cation-anion pair includes a chloride.

According to another example (“Example 25”), further to Example 17, the shell covers 99% or less of the outer region of the iron-based nanoparticle.

According to another example (“Example 26”), further to Example 17, the iron-based nanoparticle includes iron oxide.

According to another example (“Example 27”), further to Example 26, the iron oxide includes any of Fe₃O₄ or Fe₂O₃.

According to one example (“Example 28”), a composition comprises an iron-based nanoparticle having an outer region including a grain boundary and an insoluble precipitate attached to at least a portion of the grain boundary, wherein 99% or less of the grain boundary is covered by the insoluble precipitate.

According to another example (“Example 29”), further to Example 28, the insoluble precipitate includes at least one of an insoluble hydroxide or insoluble carbonate.

According to another example (“Example 30”), further to Example 28, the iron-based nanoparticle includes iron oxide.

According to another example (“Example 31”), further to Example 30, the iron oxide includes any of Fe₃O₄ or Fe₂O₃.

According to another example (“Example 32”), further to Example 28, the insoluble precipitate includes a cation-anion pair.

According to one example (“Example 33”), a mixture comprises at least one iron-based nanoparticle having an outer region and an anion-cation pair bonded to a first portion of the outer region, where a second portion of the outer region is uncovered by the anion-cation pair.

According to another example (“Example 34”), further to Example 33, the iron-based nanoparticle has a size of approximately 5 nanometers or greater.

According to another example (“Example 35”), further to Example 33, the iron-based nanoparticle has a size of approximately 40 nanometers or less.

According to another example (“Example 36”), further to Example 33, the anion-cation pair cover 99% or less of the outer region of the iron-based nanoparticle.

The foregoing Examples are just that, and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is an SEM image of a nanoparticle agglomerate, in accordance with an embodiment;

FIG. 2 is the SEM image of FIG. 1 at a higher magnification, in accordance with an embodiment;

FIG. 3 is a process flow diagram for processing nanoparticles, in accordance with an embodiment; and

FIG. 4 is a schematic of an intermediate nanoparticle, in accordance with an embodiment; and

FIG. 5 is a schematic of a shell on a region of the nanoparticle, in accordance with an embodiment

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

The term “cation” or “metal cation” as used herein generally refers to an atom that loses an electron such that the atom has an overall positive charge to form a cation. Metal cation may refer to an elemental metal that forms a cation.

The term “anion” as used herein generally refers to an atom that gains an electron in reaction such that the atom has an overall positive negative charge to form an anion.

With reference to the “capped nanoparticle”, “cation-anion coating”, “precipitate” or “shell” described herein, the terms “coating”, “bonded”, “impregnated”, “doped”, and “adhered” may be used interchangeably to indicate coverage of one or more regions of the iron-based nanoparticle.

### Description of Various Embodiments

Persons skilled in the art will readily appreciate that various aspects of the present disclosure can be realized by any number of methods and apparatuses configured to perform the intended functions. It should be noted that the accompanying drawing figures referred to herein are not necessarily drawn to scale but may be exaggerated to illustrate various aspects of the present disclosure, and in that regard, the drawing figures should not be construed as limiting.

Additionally, it is to be appreciated that certain features of the disclosure which are, for clarity, described herein in the context of separate examples, may also be provided in combination in a single example. Conversely, various features of the disclosure that are, for brevity, described in the context of a single example, may also be provided separately or in any sub-combination.

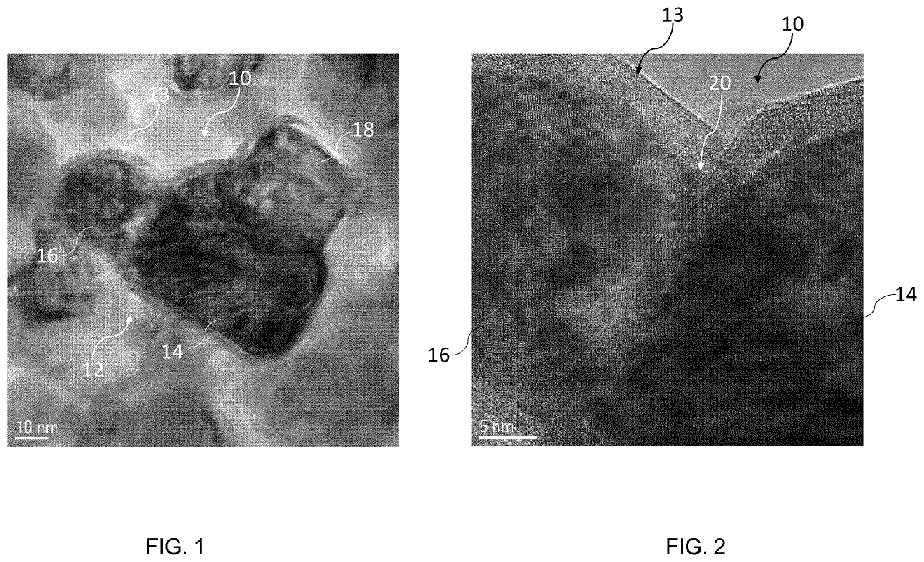

FIGS. 1 and 2 shown SEM images of a nanoparticle agglomerate 10, according to some embodiments. The nanoparticle agglomerate 10 may be formed of a plurality of individual nanoparticles. The plurality of individual nanoparticles may include iron-based nanoparticles 12 having an outer region 13. The iron-based nanoparticles 12 described herein may include iron oxide, including any one of Fe₃O₄ or Fe₂O₃. Though other forms of iron, including but not limited to, rust, ferrous chloride (FeCl₂), and ferric chloride (FeCl₃), are contemplated.

The iron-based nanoparticles 12 may include a first nanoparticle 14, a second nanoparticle 16, and a third nanoparticle 18. The nanoparticle agglomerate 10 may include one or more boundary lines 20 such as an interface, a void, an inclusion of another phase (magnetic or non-magnetic), or some other discontinuity such as a gradient in strain between each nanoparticle of the nanoparticle agglomerate 10. Although three nanoparticles are shown, in other embodiments, more than three nanoparticles, or less than three nanoparticles may form the nanoparticle agglomerate 10.

As shown in FIG. 1, each of first, second, and third nanoparticles 14, 16, 18 may be shaped and sized differently from each other. In some embodiments, as shown in FIG. 1, each the first, second, and third nanoparticles 14, 16, 18 comprise of non-spherical, or irregular shapes, wherein the irregular shapes are all different from each other. As such, the corresponding outer regions 13 and perimeters of each the first, second, and third nanoparticles 14, 16, 18 may include varying topographies that include both smooth and non-smooth outer regions.

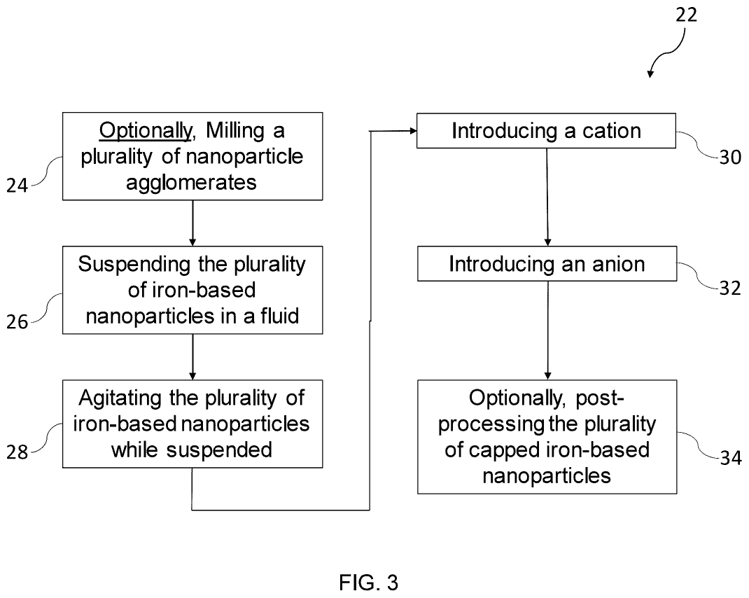

To reduce coalescing and the formation of nanoparticle agglomerates 10, additional processing steps may be necessary. FIG. 3 illustrates a process 22 for processing iron-based nanoparticles, in accordance with an embodiment. The process 22 may reduce the formation of nanoparticle agglomerates 10 and increase the amount of exposed surface area of the individual nanoparticles. The process is described with respect to a plurality of iron-based nanoparticles 12, which may include nanoparticles that are substantially similar to the first, second, and third nanoparticles 14, 16, 18.

The process 22 of FIG. 3 may include a plurality of steps including optionally, milling the plurality of nanoparticle agglomerates 24; suspending the plurality of iron-based nanoparticles in a fluid 26; agitating the plurality of iron-based nanoparticles while suspended 28; introducing a cation 30; introducing an anion 32; and optionally, post-processing the plurality of capped iron-based nanoparticles 34.

In some embodiments, milling a plurality of nanoparticle agglomerates 24 is optionally preformed. Milling may help break the nanoparticle agglomerates 10 into the plurality of iron-based nanoparticles 12 prior to further processing steps and may aid in the ability of the plurality of iron-based nanoparticles 12 to disperse within a fluid. In processes in which milling is performed, milling the plurality of nanoparticle agglomerates 24 may include a wet ball milling process in a fluid medium. The fluid medium may include at least one of deionized (DI) water or a solvent. Prior to milling, the nanoparticle agglomerates 10 may be greater than approximately 100 microns in size. The plurality of nanoparticle agglomerates 10 may be milled until a median size of the nanoparticle agglomerates 10 measures at approximately 50 microns or less, optionally approximately 10 microns or less, and optionally approximately 2 microns or less. The size of the nanoparticle agglomerates 10 may be between approximately 50 microns to 40 microns, between approximately 40 microns to 30 microns, between approximately 30 microns to 20 microns, between approximately 20 microns to 10 microns, between approximately 10 microns to 5 microns, or between approximately 5 microns to 2 microns. The median size (e.g., a D50) may be measured by laser diffraction. In other embodiments, milling steps may not be performed as the plurality of iron-based nanoparticles 12 may be received pre-milled or at a predetermined size. In some embodiments, the predetermined size of the iron-based nanoparticles 12 is approximately 30 nanometers or less, or between approximately 30 nanometers and 25 nanometers, between approximately 25 nanometers and 20 nanometers, between approximately 20 nanometers and 15 nanometers, between approximately 15 nanometers and 10 nanometers, between approximately 10 nanometers and 5 nanometers, or between approximately 5 nanometers and 1 nanometer.

After optionally milling the plurality of nanoparticle agglomerates 24, steps for suspending the plurality of iron-based nanoparticles in a fluid 26 may be performed. The fluid may include at least one of deionized (DI) water, a solvent (e.g., a polar solvent) or an hydroxide, such as lithium, sodium, potassium, rubidium, and cesium hydroxide (or another strong base hydroxide). In some embodiments, the fluid medium of the milling process is used to suspend the plurality of iron-based nanoparticles 12.

After suspending the plurality of iron-based nanoparticles in a fluid 26, steps of agitating the plurality of iron-based nanoparticles while suspended 28 may be performed. Agitating the plurality of iron-based nanoparticles 12 may include, but is not limited to, mechanical agitation including at least one of stirring and mixing. The mechanical agitation may create an environment in which the plurality of iron-based nanoparticles 12 are uniformly suspended with the fluid medium. The plurality of iron-based nanoparticles 12 may be agitated within a vessel, including but not limited to, a reactor vessel. In some embodiments, agitating the plurality of iron-based nanoparticles includes using a stirrer, such as an overhead agitator stirrer, having an agitator coupled thereto. The agitator may include a multi-blade axial flow agitator having three blades or four blades. Optionally, a diameter of the stirrer may be approximately one-third a width of the vessel, where the vessel contains the fluid and plurality of iron-based nanoparticles. In some embodiments, the stirrer agitates the fluid and plurality of iron-based nanoparticles at approximately 400 RPM for approximately 15 minutes, or until the fluid is determined to be relatively uniform and/or in equilibrium. In some embodiments, a color indicator may be added to the fluid to give a visual indication of a relatively uniform mix.

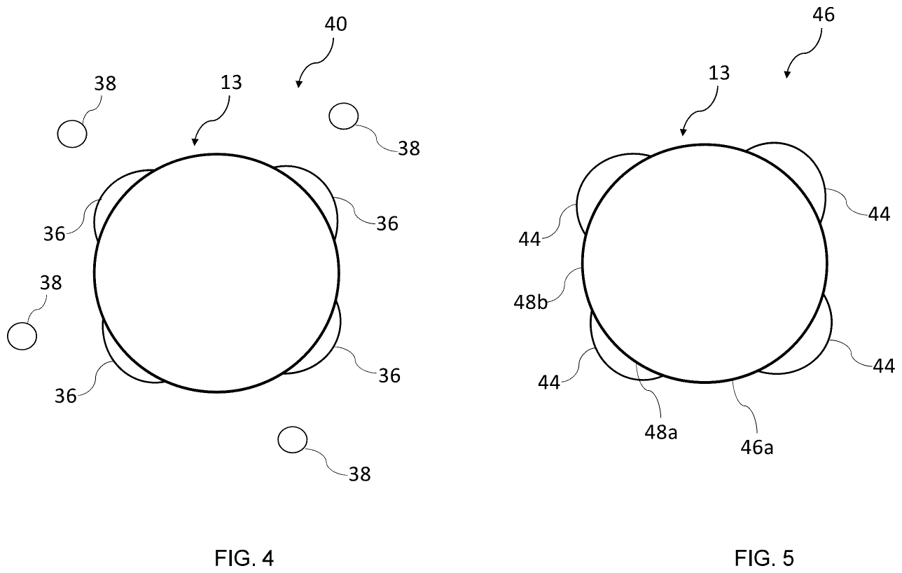

While the plurality of iron-based nanoparticles 12 are being agitated, steps of introducing a cation 30 may be performed. Introducing the cation 30 may be performed after the fluid and plurality of iron-based nanoparticles are determined be relatively uniformly mixed. The cation 36 itself may be suspended in a fluid prior to introduction. The fluid may be identical or different from the fluid used for suspending the nanoparticles. The cation 36 may be introduced to the vessel to form a mixture comprising the cation 36, the plurality of iron-based nanoparticles 12, and the fluid. The mixture may be continuously agitated after introducing the cation 36, which facilitates exposure of the cation to the outer region 13 of the plurality of iron-based nanoparticles 12. The continuous agitation may also help facilitate relatively uniform mixing of the mixture. Due to their positive charges, the cation 36 may associate, or form relatively weak bonds, with one or more portions 46a of the outer region 13 of the plurality of iron-based nanoparticles 12, to form a first layer on at least a portion of the outer region 13 to define an intermediate nanoparticle 40, as shown in FIG. 4.

After introducing the cation 30, steps of introducing an anion 32 may be performed. The anion 38 itself may be suspended in same fluid of the mixture prior to introduction. Upon introduction, the anion 38, the fluid, and the intermediate nanoparticle 40 (FIG. 4) may be continuously agitated to encourage the anion 38 to find and react with the cation 36 and encourage relatively uniform contact with the iron-based nanoparticles 12. The anion 38 may react with the cation 36 of the intermediate nanoparticle 40 due to attraction between the respective negative and positive charges. This results in formation of a cation-anion coating, or a shell 44, on the one or more portions 48a of the outer region 13 of the iron-based nanoparticles 12, which defines an iron-based capped nanoparticle 46, as shown in FIG. 5. The shell 44 may cover less than all of the outer region 13, and optionally, approximately 99% or less of the outer region 13, as subsequently described. Another portion 48b of the iron-based capped nanoparticle 46 may be uncovered by the shell 44 and exposed to the environment.

The shell's 44 coverage of the outer region 13 of the iron-based nanoparticles 12 may be impacted, at least in part, by the volume or mass of the cation 36 and anion 38 present in the mixture, and/or rates of introducing the cation 36 and anion 38. The cation 36 may be introduced at a target molar ratio of cation 36 to iron-based nanoparticles 12. The target molar ratio for the cation 36 may be less than approximately 5% molar ratio, optionally approximately 2.5%, between approximately 0.1% to approximately 0.5%, between approximately 0.5% to approximately 1%, between approximately 1% to approximately 1.5%, between approximately 1.5% to approximately 2%, between approximately 2% to approximately 2.5%, between approximately 2.5% to approximately 3%, between approximately 3% to approximately 3.5%, between approximately 3.5% to approximately 4%, between approximately 4% to approximately 4.5%, or between approximately 4.5% to approximately 5%. In other embodiments, the cation 36 may be introduced as a target weight percent of cation 36 relative to the iron-based nanoparticles 12. The target weight percent can vary depending on the type of cation 36 selected, as described further below. The target weight percent of cation 36 may be approximately 16.5 wt % or less, between approximately 0.04 wt % to 16.5 wt %, between approximately 0.04 wt % to 4 wt %, between approximately 4 wt % to 8 wt %, between approximately 8 wt % to 12 wt %, or between approximately 12 wt % to 16.5 wt %. In this way, the cation 36 is the limiting agent in formation of the shell 44. The continuous agitation of the cation 36 and iron-based nanoparticles 12 encourages relatively uniform mixing such that the cation 36 finds and reacts with the outer region 13 of each iron-based nanoparticles of the plurality of iron-based nanoparticles 12.

The anion 38 may be introduced in excess of the target molar ratio of the cation 36 to help ensure the cation 36 is fully reacted. The anion 38 may be introduced in a dip-feeding process. In some embodiments, the anion 38 may be introduced at a substantially uniform rate between approximately 1 to 100 mol/hour, optionally approximately 19 mol/hour, between approximately 17 mol/hour to 18 mol/hour, between approximately 1 mol/hour to 10 mol/hour, between approximately 10 mol/hour to 20 mol/hour, between approximately 20 mol/hour to 30 mol/hour, between approximately 30 mol/hour to 40 mol/hour, between approximately 40 mol/hour to 50 mol/hour, between approximately 50 mol/hour to 60 mol/hour, between approximately 60 mol/hour to 70 mol/hour, between approximately 70 mol/hour to 80 mol/hour, between approximately 80 mol/hour to 90 mol/hour, or between approximately 90 mol/hour to 100 mol/hour. In other embodiments, the anion 38 may be introduced as a target weight percent relative to the iron-based nanoparticles 12. The target weight percent can vary depending on the type of anion 38 selected, as described further below. The target weight percent of anion 38 may be approximately 9500 g/h or less, between approximately 17 g/h to 9500 g/h, between approximately 17 g/h to 1500 g/h, between approximately 1500 g/h to 3000 g/h, between approximately 3000 g/h to 4500 g/h, between approximately 4500 g/h to 6000 g/h, between approximately 6000 g/h to 7500 g/h, or between approximately 7500 g/h to 9500 g/h.

The rate of anion 38 introduction may be selected to achieve a final molar ratio of anion 38 to iron-based nanoparticles 12 of between approximately 0.3 to 0.4, optionally 0.34, between approximately 0.3 to 0.32, between approximately 0.32 to 0.34, between approximately 0.34 to 0.36, between approximately 0.36 to 0.38, or between approximately 0.38 to 0.4. In other embodiments, a total volume of the anion 38 may be introduced at the same time instead of at a substantially uniform rate.

In other embodiments, the reverse is contemplated in which the anion 38 is the limiting agent and is introduced first to the iron-based nanoparticles 12 at the target concentration (e.g., target molar ratio) and the cation 36 is introduced second to the iron-based nanoparticles 12 in excess of the target concentration.

The shell's 44 coverage of the outer regions 13 may also be impacted by temperature of the reaction, and continuous agitation. The process of forming the shell 44 may be performed at room temperature (e.g., at approximately 20° C.-30° C.) without additional heating. In other embodiments, forming the shell 44 may be performed at temperatures above room temperature, such as approximately 95° C. or less. The process may also be done at a standard atmospheric pressure (e.g., about 1 atm). By using continuous agitation, the reaction of the cation 36 and anion 38 is encouraged to go to completion through relatively uniform mixing of the cation 36, anion 38, and plurality of iron-based nanoparticles 12.

Once the iron-based capped nanoparticles 46 are formed, steps of post-processing the plurality of capped iron-based nanoparticles 34 may optionally be performed. The fluid may be removed from the vessel, leaving the iron-based capped nanoparticles 46 isolated. The iron-based capped nanoparticles 46 then may be optionally rinsed with deionized (DI) water or distilled water one or more times. The cation-anion precipitate of shell 44 is an insoluble precipitate with low solubility in water, and other polar solvents, and as such does not dissolve during subsequent processing steps, such as rinsing steps. As such, during rinsing steps, the shell 44 will not be removed from the iron-based capped nanoparticle 46 and remains bonded to the one or more outer regions 13. After rinsing, the iron-based capped nanoparticles 46 may be dried to remove any excess fluid.

The presence of the shell 44 on the iron-based capped nanoparticle 46 may be verified using an X-ray photoelectron spectroscopy (XPS) measurement. The elemental components of the shell 44 may be present at lower overall concentrations compared to iron or iron oxide but are shown to remain present after the steps of process 22 as described above.

FIG. 5 is a schematic of the shell 44 on the outer region 13 of the iron-based nanoparticles 12, in accordance with an embodiment. Although the iron-based capped nanoparticle 46 is shown as spherical, other non-spherical or irregular shapes are contemplated such as, for example, the shapes described above with respect to FIGS. 1-2.

The cation 36 of shell 44 may be selected from halides of the periodic table. The cation 36 may be a metal cation selected from groups including alkali metals, alkaline earth metals, or transition metals. The cation 36 may be introduced as a compound or may by introduced in ionic form. In some examples, the cation 36 is introduced to the plurality of iron-based nanoparticles as a compound, such as a chloride (e.g., MCl₂, where M refers generically to a metal), such as CaCl₂, where M is a divalent compound (e.g., carries a 2+ charge in ionic form). MCl₂ (including CaCl₂) is soluble in water such that when introducing the cation 30, MCl₂ may separate into M²⁺ ions and Cl⁻ ions, where the M²⁺ ions weakly bond to the outer region 13 of the iron-based nanoparticles 12. The metal cation (M) may include, but is not limited to, calcium (Ca²⁺), magnesium (Mg²⁺), strontium (Sr²⁺), barium (Ba²⁺), manganese (Mn²⁺), or chromium (Cr²⁺).

The anion 38 of shell 44 may include, but is not limited to, an oxide (O₂), a hydroxide (OH⁻), a bicarbonate (HCO₃⁻), or a carbonate (CO₃²⁻). The anion 38 may be introduced as a compound including but not limited to, ammonium carbonate ((NH₄)₂CO₃), sodium carbonate (Na₂CO₃), ammonium hydroxide (NH₄OH), or sodium hydroxide (NaOH). Similar to the cation compound, ((NH₄)₂CO₃) (and any of the other above-mentioned compounds) is soluble in water such that ((NH₄)₂CO₃) will separate into ammonium (NH₄⁺) ions and carbonate (CO₃²⁻) ions, where the carbonate (CO₃²⁻) ions react with the metal M²⁺ ions on the outer region 13. The anion 38 may optionally include a phosphate, including but not limited to at least one of a monobasic phosphate (HPO₄²⁻), a dibasic phosphate (H₂PO⁴—), a trisodium phosphate (Na₃PO₄) and an ammonium phosphate ((NH₄)₃PO₄). The cation 36 and anion 38 precipitate can then nucleate and grow on the outer region 13 of the iron-based nanoparticles 12 to form the shell 44. In formation, the shell 44 may form a single layer on the outer region 13 of the iron-based nanoparticles 12, may stack on top of on another, or may be a combination of both growths. The shell 44 bonds to the outer region 13 of the iron-based nanoparticle and covers at least a portion 46a of the iron-based nanoparticle. The shell 44 comprises an insoluble cation-ion precipitate that does not dissolve in water or other polar solvents, and the shell 44 may include but is not limited to, manganese hydroxide (Mn(OH)₂), manganese dioxide (MnO₂), chromium hydroxide (Cr(OH)₃), calcium carbonate (CaCO₃), magnesium carbonate (MgCO₃), strontium carbonate (SrCO₃), or barium carbonate (BaCO₃). In addition to being insoluble, the cation-anion precipitate of shell 44 may also be thermally stable such that the iron-based capped nanoparticle 46 can be exposed to elevated temperatures in subsequent processes and still retain the shell 44 on the outer region 13. The elevated temperatures may be between approximately 220° C. to 350° C., between approximately 220° C. to 250° C., between approximately 250° C. to 300° C., or between approximately 300° C. to 350° C.

In some embodiments, using CaCO₃ or BaCO₃ as the anion 38 led to a smaller nanoparticle size and a tighter size distribution (a lower standard deviation) in the iron-based capped nanoparticles 46 relative to using either MgCO₃ or SrCO₃ as the anion 38. This may be due to CaCO₃ or BaCO₃ having a lower solubility, or higher resistance to removal in rising steps, than either MgCO₃ or SrCO₃. As such, using CaCO₃ or BaCO₃ may be more resistant to removal from the outer regions 13 of the iron-based nanoparticles 12 which may help reduce instances of nanoparticle agglomeration formation post-formation of the shell 44.

After formation of the shell 44, excess chloride ions (Cl⁻), ammonium ions (NH₄⁺) or sodium ions (Na⁺), and any reacted NH₄Cl, NaCl, or ClOH compounds may be disposed of with the fluid in the post-processing steps described above. The ions, compounds, and fluid of the process 22 are considered non-toxic for disposal.

The shell 44 helps prevent the iron-based capped nanoparticles 46 from coalescing and forming the nanoparticle agglomerate 10, shown in FIGS. 1-2. As such, the iron-based capped nanoparticles 46 can be separated from each other and can retain a relatively small size. This can also keep the iron-based capped nanoparticles 46 from growing larger upon exposure to high heat in subsequent processes such that the iron-based capped nanoparticles 46 retain their size. In some embodiments, the mean aggregate size (e.g., a D50 size) of the plurality of iron-based nanoparticles 12 is approximately 10 microns or less, or 2 microns or less. Said differently, the average size of the plurality of iron-based nanoparticles 12 may be greater than approximately 5 microns. The iron-based nanoparticles 12 may range in size from approximately 5 nanometers or greater, approximately 40 nanometers or less, between approximately 40 nanometers and 35 nanometers, between approximately 35 nanometers and 30 nanometers, between approximately 30 nanometers and 25 nanometers, between approximately 25 nanometers and 20 nanometers, between approximately 20 nanometers and 15 nanometers, between approximately 15 nanometers and 10 nanometers, or between approximately 10 nanometers and 5 nanometers.

The shell 44 may cover one or more portions 48a of the outer region 13 of the iron-based capped nanoparticles 46 such that another one or more portions 48b are uncovered by the shell 44. The shell 44 may cover one or more of the boundary lines 20 (e.g., grain boundaries as shown in FIG. 2) of the iron-based nanoparticles 12. In some embodiments, the shell 44 covers between approximately 99% and 95% of the outer region 13, between approximately 95% and 90% of the outer region 13, between approximately 90% and 85% of the outer region 13, between approximately 85% and 80% of the outer region 13, between approximately 80% and 75% of the outer region 13, between approximately 75% and 70% of the outer region 13, between approximately 70% and 65% of the outer region 13, between approximately 65% and 60% of the outer region 13, between approximately 60% and 55% of the outer region 13, between approximately 55% and 50% of the outer region 13, between approximately 50% and 45% of the outer region 13, between approximately 45% and 40% of the outer region 13, between approximately 40% and 35% of the outer region 13, between approximately 35% and 30% of the outer region 13, between approximately 30% and 25% of the outer region 13, between approximately 25% and 20% of the outer region 13, between approximately 20% and 15% of the outer region 13, between approximately 15% and 10% of the outer region 13, between approximately 10% and 5% of the outer region 13, or between approximately 5% and 1% of the outer region 13.

In some embodiments, a thickness of shell 44 may be between approximately 1 nm and 10 nm, or optionally between approximately 1 nm and 5 nm. The thickness of shell 44 may optionally be between approximately 1 nm and 2 nm, between approximately 2 nm and 3 nm, between approximately 3 nm and 4 nm, between approximately 4 nm and 5 nm, between approximately 5 nm and 6 nm, between approximately 6 nm and 7 nm, between approximately 7 nm and 8 nm, between approximately 8 nm and 9 nm, or between approximately 9 nm and 10 nm.

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

1. A method comprising:
introducing a cation to an iron-based nanoparticle having an outer region, the cation bonding to a portion of the outer region and defining an intermediate nanoparticle; and
introducing an anion to the intermediate nanoparticle, the anion reacting with the intermediate nanoparticle to form a cation-anion coating on one or more portions of the outer region of the intermediate nanoparticle to form an iron-based capped nanoparticle.

2.-10. (canceled)

11. A method comprising:
suspending iron-based nanoparticles in a fluid;
exposing the iron-based nanoparticles to a cation to form a mixture;
mixing the mixture; and
exposing the mixture to an anion such that the anion reacts with the cation to form a precipitate on a portion of an outer region of the iron-based nanoparticle to form a capped nanoparticle.

12.-16. (canceled)

17. A composition comprising:
an iron-based nanoparticle having an outer region; and
a shell covering at least a portion of the outer region, the shell including a cation-anion pair.

18. The composition of claim 17, wherein the iron-based nanoparticle has a mean aggregate size of less than 2 microns.

19. The composition of claim 17, wherein the iron-based nanoparticle has a size of approximately 5 nanometers or greater.

20. The composition of claim 17, wherein the iron-based nanoparticle has a size of approximately 40 nanometers or less.

21. The composition of claim 17, wherein the cation-anion pair includes a metal cation including at least one of an alkali metal, an alkaline earth metal, or a transition metal.

22. The composition of claim 17, wherein the cation-anion pair includes an anion including at least one of an oxide, hydroxide, and a carbonate.

23. The composition of claim 17, wherein the cation-anion pair includes at least one of ammonium carbonate, sodium carbonate, ammonium hydroxide, sodium hydroxide, trisodium phosphate, manganese hydroxide (Mn(OH)₂), manganese dioxide (MnO₂), or ammonium phosphate.

24. The composition of claim 17, wherein the cation-anion pair includes a chloride.

25. The composition of claim 17, wherein the shell covers 99% or less of the outer region of the iron-based nanoparticle.

26. The composition of claim 17, wherein the iron-based nanoparticle includes iron oxide.

27. The composition of claim 26, wherein the iron oxide includes any of Fe₃O₄ or Fe₂O₃.

28. A composition comprising:
an iron-based nanoparticle having an outer region including a grain boundary; and
an insoluble precipitate attached to at least a portion of the grain boundary, wherein 99% or less of the grain boundary is covered by the insoluble precipitate.

29. The composition of claim 28, wherein the insoluble precipitate includes at least one of an insoluble hydroxide or insoluble carbonate.

30. The composition of claim 28, wherein the iron-based nanoparticle includes iron oxide.

31. The composition of claim 30, wherein the iron oxide includes any of Fe₃O₄ or Fe₂O₃.

32. The composition of claim 28, wherein the insoluble precipitate includes a cation-anion pair.

33. A mixture comprising:
at least one iron-based nanoparticle having an outer region; and
an anion-cation pair bonded to a first portion of the outer region,
wherein a second portion of the outer region is uncovered by the anion-cation pair.

34. The mixture of claim 33, wherein the iron-based nanoparticle has a size of approximately 5 nanometers or greater.

35. The mixture of claim 33, wherein the iron-based nanoparticle has a size of approximately 40 nanometers or less.

36. The mixture of claim 33, wherein the anion-cation pair cover 99% or less of the outer region of the iron-based nanoparticle.
